(19) United States
(12) Patent Application Publication
(10) Pub. No.: US 2026/0326926 A1
(43) Pub. Date: Oct. 22, 2026

(54) PUMP-FED PROPULSION SYSTEM FOR SPACECRAFT

(71) Applicant: Sierra Space Corporation, Louisville, CO (US)

(72) Inventors: Christopher Paul St. Clair, Madison, WI (US); Michael Ryan Orth, Middleton, WI (US); Nicholas Ryan Walker, Madison, WI (US); Daniel Lawrence Fadgen, Madison, WI (US)

(21) Appl. No.: 19/654,140

(22) Filed: Apr. 21, 2026

Related U.S. Application Data
(60) Provisional application No. 63/792,069, filed on Apr. 21, 2025.

(51) Int. Cl. B64G 1/40; F17C 13/00

(52) U.S. Cl. CPC B64G 1/4021; F17C 13/008; F17C 2223/033; F17C 2227/0128; F17C 2250/043; F17C 2250/0626; F17C 2250/0636; F17C 2265/066; F17C 2270/0194

(57) ABSTRACT

A spacecraft pump-fed propulsion system embodiments and related methods are disclosed. The pump-fed propulsion system includes a propellant tank assembly having at least one compartment for storing propellant at a controlled ullage pressure maintained by a pressurant tank assembly. A propellant pumping system increases propellant pressure from the ullage pressure to a thruster delivery pressure. A recirculation loop assembly mitigates transient pressure effects during pump startup and shutdown. A pressurized accumulator assembly positioned downstream from the pumping system stores propellant at the thruster delivery pressure and delivers propellant to one or more thrusters. A control system regulates operation of the pressurant tank assembly, pumping system, and accumulator assembly to control propellant pressure and flow. The system can be configured for monopropellant or bipropellant operation and enables generation of spacecraft delta-v values of at least 1000 meters per second while maintaining relatively low propellant tank pressures.

### CROSS-REFERENCE TO RELATED APPLICATION

The current application claims priority under 35 U.S.C. § 119(e) to U.S. provisional patent application No. 63/792,069, filed on Apr. 21, 2025, and entitled “Pump-Fed Reaction Control System for Spacecraft,” the disclosure of which is incorporated herein by reference.

### TECHNICAL FIELD

The subject matter described herein relates to various embodiments of a pump-fed propulsion system for spacecraft and related methods.

### BACKGROUND

Spacecraft propulsion subsystems for spacecraft bus product lines, such as satellites, are commonly challenged by mass and volume constraints in order to achieve desired velocities or delta-v, particularly in rideshare launch environments such as those employing Evolved Expendable Launch Vehicle (EELV) Secondary Payload Adapter (ESPA) ring (or similar) rideshare services.

Conventional propellant tank configurations, such as spherical or composite overwrapped pressure vessels, are structurally efficient pressure containers but can exhibit poor volumetric packing efficiency, such as when integrated into rectangular or irregular spacecraft envelopes. As a result, these traditional tank geometries often leave unused volume within the allocated spacecraft, reducing the total amount of propellant that can be stored.

Although various conformal or non-axisymmetric tank concepts have been explored, these approaches have typically involved design compromises related to pressure capability, manufacturability, structural complexity, and/or integration requirements. Pressure-fed propulsion systems generally remain constrained to tank geometries optimized for strength (e.g., able to withstand high internal pressures) rather than packaging efficiency, which restricts available propellant load and consequently achievable delta-v. Also, pressure-fed systems tend to have greater mass and volumes that are not ideal for smaller spacecraft.

Prior pump-fed approaches, typically developed for larger spacecraft or higher-thrust propulsion systems, have historically presented implementation challenges when considered for small satellite platforms, including issues associated with scale, integration constraints, and meeting the operational demands of fine attitude-control regimes and delta-v. As a result, the applicability of pump-based architectures to small-satellite reaction control environments has remained limited, and existing solutions do not address propellant storage maximization, propellant delivery efficiency and stability, optimization of spacecraft maneuverability, and generating greater delta-v.

### SUMMARY

The present disclosure relates generally to spacecraft propulsion systems and, more particularly, to pump-fed propulsion systems configured to provide high total delta-v capability while maintaining low propellant tank pressures, reduced structural mass, and improved operational flexibility.

In one aspect, the disclosure provides a spacecraft pump-fed propulsion system that includes a propellant tank assembly having at least one compartment for containing a propellant, and a pressurant tank assembly in fluid communication with the at least one compartment. The pressurant tank assembly is configured to maintain a controlled ullage pressure within the propellant tank assembly, which is lower than a thruster delivery pressure. A propellant pumping system is arranged in fluid communication with the propellant tank assembly and one or more thrusters and is operable to increase propellant pressure from the ullage pressure to a thruster delivery pressure. In some implementations, the pump-fed propulsion system further includes a recirculation loop assembly in fluid communication with an outlet of the propellant pumping system. The recirculation loop assembly is configured to hold a volume of pressurized propellant to mitigate transient pressure effects, such as water hammer, during startup or shutdown of the propellant pumping system. In some implementations, the pump-fed propulsion system further includes a pressurized accumulator assembly is included downstream from the recirculation loop assembly and is configured to store propellant at the thruster delivery pressure. The pressurized accumulator assembly delivers propellant at the thruster delivery pressure to at least one of the one or more thrusters, enabling responsive propulsion without requiring continuous pump operation.

Implementations of the pump-fed propulsion system further includes a control system configured to manage operation of at least the pressurant tank assembly, propellant pumping system, and pressurized accumulator assembly. In operation, the control system can maintain propellant storage at the ullage pressure within the propellant tank assembly and selectively increase the propellant pressure downstream of the propellant tank assembly to the thruster delivery pressure. Implementations of the pump-fed propulsion system his can enable generation of spacecraft maneuvers associated with total delta-v values of at least 1000 meters per second, and in some embodiments at least 1500 (e.g., at least 2000 meters per second), while maintaining relatively low propellant tank pressures.

In some implementations, the pump-fed propulsion system can be configured in a monopropellant implementation in which the propellant tank assembly includes a single monopropellant compartment and the propellant pumping system includes a single monopropellant pump. Alternatively, in some implementations, the pump-fed propulsion system can be configured in a bipropellant implementation in which the propellant tank assembly includes separate fuel and oxidizer compartments separated by a common bulkhead, and the propellant pumping system includes a corresponding fuel pump and oxidizer pump. In such embodiments, separate recirculation lines and pressurized accumulators can be included for the fuel and oxidizer, and the control system can independently regulate operation of the fuel and oxidizer pumping systems.

In some implementations, the ullage pressure within the propellant tank assembly is less than 100 pounds per square inch absolute (psia), while the thruster delivery pressure exceeds 150 psia. In some implementations, the spacecraft pump-fed propulsion system can have a dry mass of 100 kg and an associated specific delta-v rating of 15 m/s-kg. The disclosed pump-fed propulsion system can include reduced tank mass, improved packaging efficiency, and support higher specific delta-v performances relative to pressure-fed systems.

In another aspect, the disclosure provides a method of operating a pump-fed propulsion system for a spacecraft. The method includes storing a propellant at a controlled ullage pressure within a propellant tank assembly having at least one compartment. The ullage pressure can be maintained using a pressurant tank assembly that delivers pressurant gas to the propellant tank assembly as propellant is consumed. The propellant can be selectively pressurized above the ullage pressure by a propellant pumping system to a thruster delivery pressure suitable for operation of one or more thrusters.

The method can further include routing pressurized propellant through a recirculation loop assembly to manage transient pressure effects associated with startup and shutdown of the propellant pumping system. The pressurized propellant can then be stored at the thruster delivery pressure within a pressurized accumulator assembly positioned downstream from the recirculation loop assembly. Propellant can be delivered from the pressurized accumulator assembly to one or more thrusters at the thruster delivery pressure, enabling controlled thrust generation. Operation of the pressurant tank assembly, propellant pumping system, and pressurized accumulator assembly can be coordinated using a control system such that the propellant is stored at the ullage pressure within the propellant tank assembly and selectively increased to the thruster delivery pressure to generate a spacecraft delta-v of at least 1000 meters per second, and in some embodiments at least 1500 meters per second.

The disclosed method can be implemented in monopropellant configurations in which the propellant tank assembly includes a single monopropellant compartment containing a monopropellant. Alternatively, the method can be implemented in bipropellant configurations in which the propellant tank assembly includes a fuel compartment and an oxidizer compartment separated by a common bulkhead. In some implementations, the ullage pressure within the propellant tank assembly is less than 100 psia, while the thruster delivery pressure exceeds 150 psia.

In accordance with some implementations, the method enables execution of multiple discrete thruster impulse bits using propellant supplied from the pressurized accumulator assembly without requiring activation of the propellant pumping system for each impulse bit. This can reduce pump cycling, lower power consumption, and improve thrust responsiveness.

Control of the propellant pumping system can include closed-loop pressure regulation. In some embodiments, the method includes receiving measured pressure data from a pressure sensor associated with the propellant pumping system, receiving a pressure setpoint corresponding to a commanded operating state, determining a pressure difference, and generating a pump speed change instruction based on the pressure difference. The pump speed change instruction can be limited within predetermined bounds and used to generate a pump speed ramp command, which can be combined with a prior pump speed command or a measured pump speed to generate a new pump speed command that is constrained within an allowable operating range.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a diagram illustrating features of a pump-fed propulsion system integrated into a spacecraft consistent with implementations of the current subject matter;

FIG. 2A shows a diagram illustrating an embodiment of the pump-fed propulsion system of FIG. 1;

FIG. 2B shows a diagram illustrating another embodiment of the pump-fed propulsion system;

FIG. 3 illustrates an example pump control algorithm diagram that can be executed by a control system of the pump-fed propulsion systems of FIGS. 2A and 2B for controlling operation of a propellant pumping system of the pump-fed propulsion system;

FIG. 4 shows a first process flow diagram illustrating aspects of a method having one or more features consistent with implementations of the current subject matter; and

FIG. 5 shows a second process flow diagram illustrating aspects of a method having one or more features consistent with implementations of the current subject matter.

When practical, similar reference numbers denote similar structures, features, or elements.

### DETAILED DESCRIPTION

The following description sets forth examples of pump-fed propulsion systems that provide reliable, high-performance propellant delivery to thrusters for spacecraft that are subject to mass and volume constraints. The spacecraft for which the pump-fed propulsion systems described herein have been configured to improve include spacecraft bus product lines, such as satellites. For example, such spacecraft have been challenged by mass and volume constraints in order to achieve desired velocities (delta-v), particularly in rideshare launch environments such as those employing Evolved Expendable Launch Vehicle (EELV) Secondary Payload Adapter (ESPA) ring (or similar) rideshare services. The pump-fed propulsion systems described herein can be configured for advantageously achieving greater delta-v, including greater specific delta-v ratings. Some example ESPA vehicle configurations of which the pump-fed propulsion systems described herein can be integrated into include small ESPA vehicle configurations, such as for rocket cargo applications, medium or standard ESPA vehicle configurations, such as for orbital tug applications, and large or stretched ESPA vehicle configurations, such as for human-rated vehicles.

The embodiments of a spacecraft pump-fed propulsion system described herein achieve performance characteristics not attainable by conventional pressure-fed or pump-fed systems, particularly in spacecraft subject to mass and volume constraints, such as smaller satellites. The pump-fed propulsion system described herein integrates structural, fluidic, and control features that cooperate to enable low-pressure, large volume propellant storage and on-demand high-pressure delivery of propellant to thrusters. The pump-fed propulsion system provides reduced system mass, higher delta-v creation, and increased maneuverability for smaller spacecraft.

Embodiments of the pump-fed propulsion system can be configured for use with a monopropellant or bipropellant. The pump-fed propulsion system includes a propellant tank assembly having one or more compartments for containing propellant. In some embodiments the propellant tank includes a single compartment for containing a monopropellant. In some embodiments, the propellant tank includes more than one compartment, such as a fuel compartment for containing fuel and an oxidizer compartment for containing oxidizer. In such an embodiment the fuel compartment and the oxidizer compartment are separated by a common bulkhead. The single propellant tank assembly with a common bulkhead results in a reduction of structural mass and size otherwise associated with separate tanks. This configuration not only reduces dry mass of the pump-fed propulsion system but also increases available internal propellant volume for a given spacecraft, enabling the storage of a greater quantity of usable propellant. As a result, the spacecraft is capable of achieving a greater total delta-v without increasing overall system size or tank operating pressure. When combined with the additional features described herein, the single propellant tank assembly contributes directly to an optimized delta-v rating with large propellant storage volumes. For example, a smaller spacecraft (e.g., small ESPA vehicle) including the pump-fed propulsion system described herein can achieve a delta-v rating of at least approximately 1,000 meters per second and store at least approximately 5 liters of propellant (with, for example, a corresponding propellant tank mass of approximately 3 kg), a medium sized spacecraft (e.g., medium ESPA vehicle) including the pump-fed propulsion system described herein can achieve a delta-v rating of at least approximately 1,500 meters per second and store at least approximately 55 liters of propellant (with, for example, a corresponding propellant tank mass of approximately 30 kg), and a larger spacecraft (e.g., large ESPA vehicle) including the pump-fed propulsion system described herein can achieve a delta-v rating of at least approximately 2,000 meters per second and store at least approximately 712 liters of propellant (with, for example, a corresponding propellant tank mass of approximately 385 kg).

Embodiments of the pump-fed propulsion system include a pressurant tank assembly that is in fluid communication with the propellant tank assembly, such as with both the fuel compartment 230 and the oxidizer compartment 240, and maintains a ullage pressure of the propellant stored in the pressurant tank assembly. The ullage pressures are selected to support pump inlet requirements rather than direct thruster feed. This distinction is important, as the pressurant tank assembly 310 enables the propellant tank assembly 210 to remain at relatively low operating pressure (e.g., compared to the downstream thruster delivery pressure), thereby allowing thinner propellant tank walls and further increasing propellant tank volume for storing propellant.

Embodiments of the pump-fed propulsion system further include a propellant pumping system 410 in fluid communication with the propellant tank assembly 210 and one or more thrusters. The propellant pumping system 410 increases the propellant pressure, such as a fuel pressure and an oxidizer pressure, to a thruster delivery pressure downstream of the propellant tank assembly. This allows for higher propellant pressures that are required for fueling high performance thrusters, which can assist with generating high delta-v, without storing propellant at such higher pressures, which can require larger and more robust propellant tank assemblies. For example, the pump-fed propulsion system disclosed herein can maintain the propellant pressure in the propellant tank assembly at a storage pressure of less than 100 psia, (e.g., approximately 40 to 70 psia, such as approximately 50 psia) and the pump-fed propulsion system can be configured to increases the propellant pressure to a thruster delivery pressure of greater than 150 psia, such as within a range of approximately 150 to 500 psia, such as approximately 275 to 325 psia. Such pressure changes and control of the propellant for achieving high delta-v and efficient response and maneuverability of the spacecraft result in a variety of issues and challenges that the pump-fed propulsion system described herein addresses. For example, the propellant pumping system is designed to operate in conjunction with downstream and auxiliary features that address system issues and challenges, as will be discussed in greater detail below.

To address startup and shutdown transients commonly associated with pump-fed propulsion systems, the pump-fed propulsion system includes a recirculation loop assembly that is in fluid communication with a pump outlet of the propellant pumping system. The recirculation loop assembly includes one or more recirculation fluid lines that are configured to maintain volumes of propellant (e.g., monopropellant, fuel, oxidizer, etc.) and to prevent water hammer during startup and shutdown of the propellant pumping system. This feature allows the propellant pumping system to operate without the pressure spikes and stabilization delays that would otherwise require heavier plumbing, additional dampers, or conservative throttling. As such, the pump-fed propulsion system of the present disclosure can handle rapid thrust initiation and termination, supporting fine impulse control and repeated short-duration firings that are essential for high-precision maneuvering of a spacecraft, as well as optimizing conditions for efficiently and effectively generating high delta-v.

Embodiments of the pump-fed propulsion system further include a pressurized accumulator assembly downstream from the recirculation loop assembly. The pressurized accumulator assembly is configured to store fuel and oxidizer at the thruster delivery pressure and to deliver the pressurized propellants to one or more thrusters. The accumulator assembly enables rapid delivery of high-pressure propellant independent of the propellant pumping system. This permits fast delivery of high-pressure propellant in response to small steering commands, reduces latency between control input and thrust output, and reduces wear and power demands on the propellant pumping system.

Embodiments of the pump-fed propulsion system further include a control system that provides system-level coordination and is configured to manage operation of the pressurant tank assembly, propellant pumping system, pressurized accumulator assembly, as well as any valves or similar integrated in the system for controlling propellant storage and flow. The control system ensures that propellant is stored at a low pressure, selectively increased to a high pressure, and efficiently delivered to the thrusters in a manner that achieves a desired delta-v while minimizing mass, energy consumption, and mechanical stress. The cooperative control of these subsystems enables optimal performance characteristics of the pump-fed propulsion system, such as rapid response, high maneuverability, and increased total delta-v.

Accordingly, the described pump-fed propulsion system having the single propellant tank assembly, low-pressure storage, pump-fed pressurization, recirculation-based transient mitigation, accumulator-enabled responsiveness, and coordinated control logic collectively yield a compact, low-mass, and highly agile spacecraft propulsion solution. These features operate together to enable spacecraft to carry more usable propellant, achieve higher delta-v, and execute rapid and precise maneuvers, addressing limitations that persist in conventional propulsion systems. Embodiments of the pump-fed propulsion system are described in further detail below.

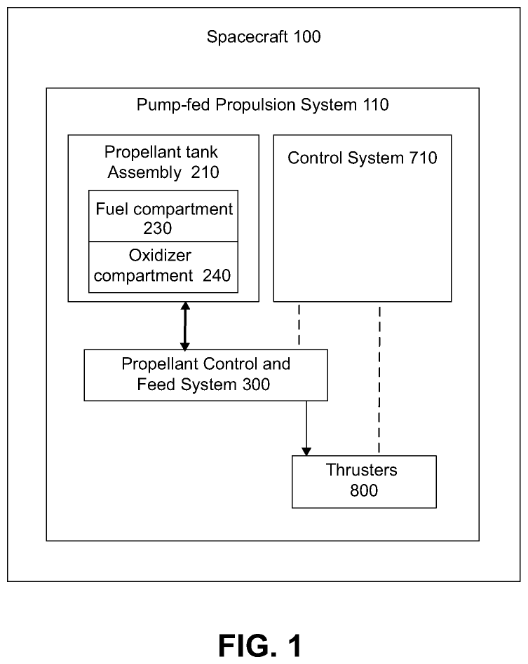

FIG. 1 is a schematic representation of a spacecraft 100 including a pump-fed propulsion system 110 configured to provide high-performance propulsion within a compact and mass-efficient system. For example, the pump-fed propulsion system 110 can be configured for a variety of spacecraft, such as small ESPA vehicle configurations, (e.g., for rocket cargo applications), medium or standard ESPA vehicle configurations (e.g., for orbital tug applications), and large or stretched ESPA vehicle configurations (e.g., for human-rated vehicles).

As shown in FIG. 1, the pump-fed propulsion system 110 includes a propellant tank assembly 210, a propellant control and feed system 300, a control system 710, and one or more thrusters 800. The depicted elements are functionally interconnected to enable low-pressure propellant storage in the propellant tank assembly 210 and controlled high-pressure delivery to the thrusters 800, thereby supporting high delta-v capability, rapid and efficient spacecraft maneuvering, and responsive thrust control.

The propellant tank assembly 210 can include one or more compartments for containing propellant. As shown in FIG. 1, the propellant tank assembly 210 can include a fuel compartment 230 configured to store a fuel and an oxidizer compartment 240 configured to store an oxidizer. In some embodiments, the fuel compartment 230 and the oxidizer compartment 240 are separated by a common bulkhead, as described in further detail below. The propellant tank assembly 210 is configured to store propellant, such as fuel and oxidizer, at relatively low pressure, such as less than 100 psia (e.g., approximately 40 to 70 psia, such as approximately 50 psia). The pressure in the propellant tank assembly 210 can be controlled and maintained by a pressurant tank assembly of the propellant control and feed system 300, as will be described in greater detail below. By consolidating storage of propellant (e.g., monopropellant, bipropellant) within a single propellant tank assembly 210, the spacecraft 100 benefits from reduced structural mass (dry mass) and increased usable propellant mas and/or volume within a given spacecraft, thereby enabling increased total delta-v.

Propellant in the propellant tank assembly 210 is delivered to parts of the propellant control and feed system 300. The propellant control and feed system 300 includes one or more components configured to manage, condition, pressurize, and route propellant between the propellant tank assembly 210 and the thrusters 800. In various embodiments, the propellant control and feed system 300 includes, by way of non-limiting example, one or more propellant pumps, pressurized accumulators, recirculation loops, valves, regulators, manifolds, filters, and associated fluid lines. For example, at least one filter can be included in the propellant fluid lines to capture and remove any particles or debris before reaching the thruster inlets.

The propellant control and feed system 300 is configured to provide precise control of propellant flow rate, pressure, and timing, thereby enabling both steady-state thrust and rapid thrust response, as well as generating high delta-v. In some embodiments, portions of the propellant control and feed system 300 operate to mitigate pressure transients during startup or shutdown of propellant flow, allowing repeated short-duration firings and fine impulse control.

The thrusters 800 are fluidly coupled to the propellant control and feed system 300 and are configured to receive pressurized fuel and oxidizer therefrom. The thrusters 800 can include main propulsion thrusters, attitude control thrusters, or a combination thereof. The ability of the propellant control and feed system 300 to rapidly supply propellant at a thruster delivery pressure enables, for example, fast reaction to small steering commands, high vehicle maneuverability, and effective generation of high delta-v.

Operation of the pump-fed propulsion system 110 is managed by the control system 710. As illustrated by dashed control lines in FIG. 1, the control system 710 is communicatively coupled to the propellant control and feed system 300 and, in some embodiments, directly or indirectly to the thrusters 800. The control system 710 is configured to command and coordinate operation of pumps, valves, accumulators, and other components within the propellant control and feed system 300, thereby controlling propellant pressurization, flow sequencing, and timing.

In operation, the control system 710 ensures that propellant is stored at a low pressure within the propellant tank assembly 210 (ullage pressure) and selectively increased to a higher pressure (thruster delivery pressure) within the propellant control and feed system 300. This allows the spacecraft 100 to achieve high performance propulsion while maintaining a compact, low-mass system configuration. The cooperative interaction between the propellant tank assembly 210, the propellant control and feed system 300, the control system 710, and the thrusters 800 provides capabilities including increased delta-v, enhanced maneuverability, and rapid thrust response that are particularly advantageous for spacecraft, including small spacecraft.

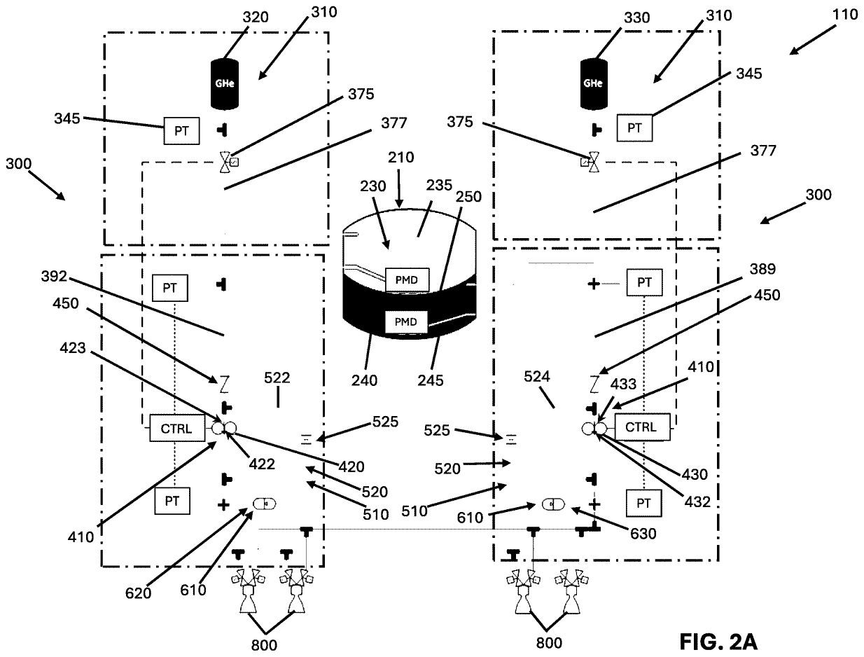

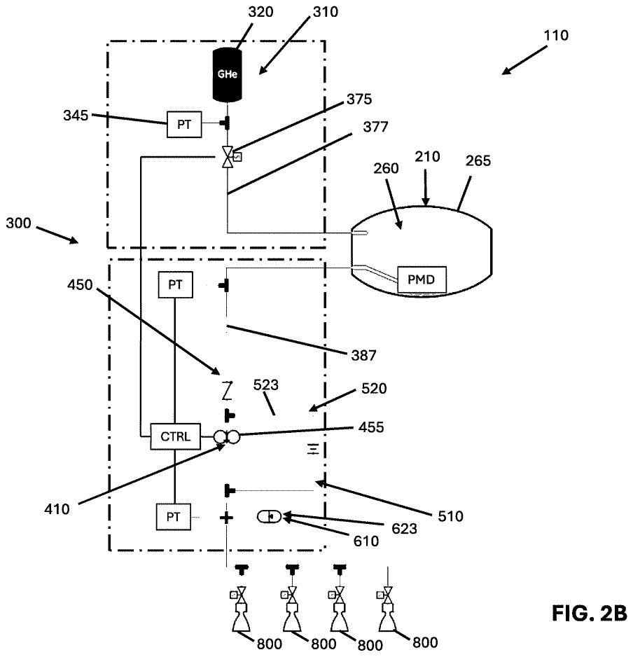

FIG. 2A illustrates a detailed embodiment of the pump-fed propulsion system 110 shown schematically in FIG. 1. As depicted, the pump-fed propulsion system 110 includes the propellant tank assembly 210, the propellant control and feed system 300, and one or more thrusters 800 in fluid communication therewith. FIG. 2A provides additional structural and functional detail regarding these components and their interrelation.

The propellant tank assembly 210 includes one or more compartments for containing propellant. In some embodiments, the propellant tank assembly 210 is configured as a single propellant storage tank that includes a fuel compartment 230 for containing fuel 235 and an oxidizer compartment 240 for containing oxidizer 245. As shown in FIG. 2A, the fuel compartment 230 and the oxidizer compartment 240 are separated from one another by a common bulkhead 250. The use of a common bulkhead enables the fuel and oxidizer to be contained within a shared compact structure while remaining physically isolated, thereby reducing tank materials and support structures.

In some embodiments, the propellant tank assembly 210 includes non-axisymmetric or conformal tank geometries. Such geometries allow the propellant tank assembly 210 to conform to available spacecraft volumes that are not well suited to spherical or cylindrical tanks. This configuration enables maximum utilization of limited internal spacecraft storage space, allowing a greater fraction of the available area within the spacecraft to be allocated to propellant storage.

In some embodiments, the propellant tank assembly 210 is fabricated using Selective Laser Sintering (SLS) or a similar additive manufacturing process. Additive fabrication enables the formation of complex internal and external geometries, including the common bulkhead 250 and integrated features, without the manufacturing constraints associated with traditional high-pressure vessel fabrication techniques. As a result, the propellant tank assembly 210 can be optimized for both structural and volumetric efficiency.

In one or more embodiments, the propellant tank assembly 210 of the pump-fed propulsion system 110 provides at least 40 percent greater usable propellant volume relative to a spherical tank or a composite overwrapped pressure vessel having an equivalent external envelope. The increased usable propellant volume directly translates to increased total stored propellant for a spacecraft of a given size. In some embodiments, this increase in propellant volume provides a corresponding delta-v improvement of up to approximately 42 percent, depending on mission parameters and propulsion configuration.

In some embodiments, each of the fuel compartment 230 and the oxidizer compartment 240 includes a surface tension propellant management device positioned adjacent to a respective tank outlet. The surface tension propellant management devices are configured to promote reliable propellant delivery to downstream components under low-gravity or microgravity conditions, ensuring consistent flow of propellant from the propellant tank assembly 210 to the propellant control and feed system 300 throughout mission operations.

The structural configuration, manufacturing approach, and internal features of the propellant tank assembly 210 enable increased propellant storage within a compact and lightweight tank structure. When integrated into the pump-fed propulsion system 110, the propellant tank assembly 210 contributes directly to achieving increased delta-v capability while maintaining the small size and low mass required for modern spacecraft, particularly small satellites. These improvements provide a benefit upon which the downstream pump-fed architecture and control features operate to further optimize overall spacecraft performance.

As shown in FIG. 2A, the pump-fed propulsion system 110 can further include a pressurant tank assembly 310, which can form part of the propellant control and feed system 300 shown in FIG. 1. The pressurant tank assembly 310 is configured to maintain controlled ullage pressures within the propellant tank assembly 210 while propellant is dispensed, thereby enabling reliable propellant delivery to downstream components of the propulsion system.

In one or more embodiments, the pressurant tank assembly 310 includes a pressurant supply comprising one or more pressurant tanks, such as multiple pressurant tanks each independently regulating ullage pressure within a respective propellant compartment. For example, a first pressurant tank 320 can be in fluid communication with the fuel compartment 230, and a second pressurant tank 330 can be in fluid communication with the oxidizer compartment 240. Independent regulation of the fuel and oxidizer ullage pressures allows different control of propellant volumes having different densities and flow requirements.

In some embodiments, one or more pressurant tanks of the pressurant tank assembly 310 are filled with a pressurant gas, such as helium, which is supplied to the respective propellant tank volumes to displace propellant as propellant is withdrawn from the propellant tank assembly 210. As pressurant gas is introduced into a propellant volume, it occupies ullage space and maintains a controlled ullage pressure as propellant is delivered to the propellant control and feed system 300.

In one or more embodiments, the pressurant tank assembly 310 is configured to maintain relatively low storage or ullage pressures of below 100 psia (e.g., approximately 40 to 70 psia, such as 50 psia) within the fuel compartment 230 and the oxidizer compartment 240. The storage or ullage pressures of the fuel and oxidizer can be maintained at the same or different pressures (below 100 psia). Maintaining the propellant tank assembly 210 at such lower pressures reduces structural loading on the propellant tank assembly 210 and enables the use of non-axisymmetric or irregular propellant tank geometries. These low-pressure conditions are particularly advantageous for maximizing propellant storage within constrained spacecraft volumes while minimizing propellant tank mass.

In some embodiments, one or more pressurant pressure transducers 345 are fluidly coupled to the pressurant tank assembly 310 and configured to monitor the pressure within the pressurant tanks 320 and 330. Pressure data from the pressurant pressure transducers 345 is provided to the control system 710, which uses the information to assist with determining when and how much pressurant gas to release into the propellant tank assembly 210 in order to maintain desired ullage pressures during system operation.

In one or more embodiments, the pressurant tank assembly 310 includes one or more valves 375 positioned along a pressurant fluid line 377 extending between a pressurant tank and the propellant tank assembly 210. Such valves 375 can include, for example, solenoid valves, pyrotechnically actuated valves, and/or manual fill or drain valves. The valves 375 are actuated by the control system 710 to control the flow of pressurant gas into the fuel compartment 230 and the oxidizer compartment 240.

Although the pressurant tank assembly 310 maintains propellant storage pressures at relatively low levels, other components of the propellant control and feed system 300 are configured to substantially increase the pressure of the propellant downstream of the propellant tank assembly 210. In some embodiments, propellant pressure is increased to greater than 150 psia (e.g., approximately 150 to 500 psia, approximately 275 to 325 psia) for delivery to the thrusters 800. This configuration allows high thruster chamber pressures and increased thrust efficiency and delta-v to be achieved without requiring the propellant tank assembly 210 to contain highly pressurized propellant.

Accordingly, the pressurant tank assembly 310, in cooperation with the propellant tank assembly 210, the propellant control and feed system 300, and the control system 710, supports the pump-fed propulsion system 110 in which propellant is stored at low pressure, delivered to one or more thrusters 800 at high pressure, and controlled with precision. This contributes to a compact, low-mass propulsion system capable of supporting increased delta-v and high maneuverability for spacecraft.

As further shown in FIG. 2A, the pump-fed propulsion system 110 includes a propellant pumping system 410 and a recirculation loop assembly 510 forming part of the propellant control and feed system 300. These components cooperate to increase propellant pressure from a low storage pressure within the propellant tank assembly 210 to a thruster delivery pressure, while maintaining controlled startup and shutdown, mitigating or reducing water hammer, and enabling rapid and repeatable thruster operation.

In accordance with the illustrated embodiment, the propellant pumping system 410 is in fluid communication with the propellant tank assembly 210 and with one or more thrusters 800. The propellant pumping system 410 is configured to increase propellant pressure. For example, the propellant pumping system 410 is configured to increase a fuel pressure and an oxidizer pressure from respective propellant compartment outlet pressures (ullage pressures) to a thruster delivery pressure suitable for efficient combustion within the thrusters 800.

In some embodiments, a burst disc valve can included in the propellant fluid line (e.g., a fuel fluid line 392 and/or an oxidizer fluid line 389), downstream from the propellant tank assembly 210. The burst disc valve can prevent propellant from reaching components further downstream, such as until the control system 710 instructs the burst disc valve to allow propellant flow past the burst disc valve.

In one or more embodiments, the propellant pumping system 410 increases the fuel pressure from a first fuel pressure (e.g., ullage pressure) when the fuel is released from the propellant tank assembly 210 to a second fuel pressure or thruster delivery pressure when the fuel is delivered to the one or more thrusters 800, the second fuel pressure being greater than the first fuel pressure. In some embodiments, the first fuel pressure is less than 100 psia (e.g., approximately 40 psia to approximately 70 psia, such as approximately 50 psia), corresponding to the controlled ullage pressure maintained by the pressurant tank assembly 310, and the second fuel pressure is greater than 150 psia (e.g., approximately 150-500 psia, approximately 275 to 325 psia) at thruster delivery. Similar pressure relationships apply to the oxidizer.

In some embodiments, the propellant pumping system 410 includes a fuel propellant pump 420 in fluid communication with the fuel compartment 230 and an oxidizer propellant pump 430 in fluid communication with the oxidizer compartment 240. For example, each pump can be implemented as a magnetically coupled gear pump.

In some embodiments, the fuel propellant pump 420 and the oxidizer propellant pump 430 are configured to operate in a variable speed mode. For example, pump speed can be adjusted dynamically in response to feedback from one or more pressure sensors, pump speed sensors, and temperature sensors positioned throughout the propellant control and feed system 300. Sensor data is monitored by the control system 710, which regulates pump operation to achieve desired propellant flow rates, pressures, and thermal conditions

To stabilize propellant flow, the propellant control and feed system 300 further includes a recirculation loop assembly 510 in fluid communication with the propellant pumping system 410. As shown in FIG. 2A, the recirculation loop assembly 510 can be in fluid communication with a fuel pump outlet 422 and an oxidizer pump outlet 432 of the propellant pumping system 410. The recirculation loop assembly 510 can include one or more recirculation fluid lines 520 configured to maintain volumes of propellant, such as fuel and oxidizer, in circulation and to prevent water hammer during startup or shutdown of the propellant pumping system 410.

In some embodiments, the recirculation fluid lines 520 comprise a fuel recirculation line 522 and an oxidizer recirculation line 524. The fuel recirculation line 522 provides a fluid pathway between the fuel pump outlet 422 and a fuel pump inlet 423, while the oxidizer recirculation line 524 provides a fluid pathway between the oxidizer pump outlet 432 and an oxidizer pump inlet 433. By recirculating a portion of the pumped propellant, pressure changes are smoothed and flow continuity is maintained through the pumps.

In some embodiments, the recirculation fluid lines 520 include a trim orifice 525. The trim orifice 525 can be a small, non-adjustable orifice positioned in the fuel recirculation line 522 and/or the oxidizer recirculation line 524 to slightly restrict flow and assist with maintaining the fuel and oxidizer within a desired pressure or flow rate range. In one or more embodiments, approximately 10 percent of the pumped propellant volume is captured along the recirculation fluid lines 520. This controlled recirculation volume contributes to pressure stability and flow damping without materially reducing delivered thrust efficiency.

FIG. 2A illustrates the relative placement and interconnection of the fuel propellant pump 420, oxidizer propellant pump 430, and recirculation fluid lines 520 within the pump-fed propulsion system 110. In cooperation with the pressurant tank assembly 310, the propellant pumping system 410 and recirculation loop assembly 510 enable propellant to be stored at low pressure (ullage pressure), rapidly increased to high pressure (thruster delivery pressure) on demand, and delivered to the thrusters 800 with controlled startup and shutdown behavior. This integrated architecture contributes to a propulsion system that achieves high delta-v performance while remaining compact, lightweight, and well suited for spacecraft applications.

As shown in FIG. 2A, and downstream from the recirculation loop assembly 510, the pump-fed propulsion system 110 includes a pressurized accumulator system 610 configured to store pressurized propellant and to deliver the pressurized propellant to one or more thrusters 800 with rapid response and stable pressure characteristics. The pressurized accumulator system 610 forms part of the propellant control and feed system 300 and cooperates with the propellant pumping system 410 to allow thruster operation to function with or without pump operation.

In some embodiments, the pressurized accumulator assembly 610 is positioned downstream from the recirculation loop assembly 510 and is configured for storing fuel and oxidizer at a thruster delivery pressure and delivering the pressurized fuel and oxidizer to the one or more thrusters 800. In some embodiments, the thruster delivery pressure is greater than 150 psia (e.g., approximately 150 to 500 psia, approximately 275 to 325 psia), consistent with the delivery pressure generated by the propellant pumping system 410.

As shown in FIG. 2A, the pressurized accumulator assembly 610 can include a fuel accumulator 620 for containing pressurized fuel and an oxidizer accumulator 630 for containing pressurized oxidizer. Each accumulator is fluidly coupled to the propellant pumping system 410 and recirculation loop assembly 510 and is configured to receive propellant that has been raised to the thruster delivery pressure.

In some embodiments, each of the fuel accumulator 620 and the oxidizer accumulator 630 includes a pneumatic volume charged with a pressurant gas, such as helium. The pressurant gas within each accumulator acts as a compliant pneumatic absorber, allowing the accumulator to store propellant energy elastically and to deliver propellant to the thrusters 800 with minimal pressure fluctuation during firing events.

In some embodiments, each accumulator is sized to support multiple impulse bits without requiring recharge by the propellant pumping system 410. This configuration allows the thrusters 800 to execute repeated short-duration firings, such as during attitude control or station-keeping maneuvers, without requiring the pumps to be activated for each individual pulse. Avoiding frequent pump start-stop cycles reduces mechanical wear on the pumps and reduces energy consumption.

During pulsed thruster operation, the pressurized accumulator assembly 610 is configured to maintain a stable thruster delivery pressure. In some embodiments, this stability enables the mixture ratio at the thruster inlet to be maintained within a tolerance of approximately plus or minus 5 percent during pulsed operation, thereby supporting consistent combustion performance and predictable impulse delivery.

In addition, the fuel accumulator 620 and oxidizer accumulator 630 allow intermittent thruster firings to rely primarily on the stored energy within the pressurized accumulator assembly 610, rather than on real-time pump control. This approach provides improved and efficient propellant flow to the thrusters 800 and improves overall propulsion efficiency, particularly when involving frequent attitude adjustments.

In some embodiments, at least one check valve 450 can be included along one or more fluid lines in the propellant control and feed system 300. For example, the pressurized accumulator assembly 610 can include a check valve disposed at an inlet of each of the fuel accumulator 620 and the oxidizer accumulator 630. The check valves are configured to prevent backflow of propellant from the accumulators toward the propellant pumping system 410, ensuring that pressurized propellant remains available for immediate delivery to the thrusters 800. In some embodiments, delivery of a volume of the propellant to the thrusters 800 can be supplied directly from the propellant pumping system 410, such as without the volume of propellant having been stored in the pressurized accumulator assembly 610. In some embodiments, the pressurized accumulator assembly 610 includes an isolating valve (a passive flow control device) that assists with providing the propellant at the thruster delivery pressure, such as while a pump of the propellant pumping system 410 is inactive.

In some embodiments, one or more valves in the propellant control and feed system 300 can be actively controlled, such as by the control system, (e.g., in the pressurant tank assembly 310) and/or passively controlled, such as not connected to the control system, (e.g., in the propellant pumping system 410).

Collectively, the pressurized accumulator assembly 610, in cooperation with the propellant pumping system 410 and the recirculation loop assembly 510, enables fast thruster response, smooth pulsed operation, and high-pressure propellant delivery without requiring continuous pump operation. This functionality contributes significantly to a compact, low-mass propulsion system capable of high maneuverability, efficient energy usage, and increased delta-v performance for spacecraft operating within mass and volume limits.

In some embodiments, the fuel flow path and oxidizer flow path are implemented on separate panels, referred to as a fuel supply panel and an oxidizer supply panel, which can be positioned to at least partially surround the propellant tank assembly 210. For example, the fuel and oxidizer supply panels can each support components of the propellant control and feed system 300 associated with their respective propellants. The overall layouts of the two panels can be similar, differing only where required for propellant-specific considerations. Separating the fuel and oxidizer flow paths onto dedicated panels can facilitate modular assembly, compact packaging around the propellant tank assembly 210, and physical separation between propellant systems.

FIG. 2B illustrates an additional embodiment of the pump-fed propulsion system 110. As depicted, the pump-fed propulsion system 110 includes an embodiment of the propellant tank assembly 210, an embodiment of the propellant control and feed system 300, and one or more thrusters 800 in fluid communication therewith. FIG. 2B provides additional structural and functional detail regarding these components and their interrelation.

The pump-fed propulsion system 110 embodiment shown in FIG. 2B is configured for use with a monopropellant 265 (e.g., hydrazine). In this embodiment, the propellant tank assembly 210 comprises a single propellant compartment, such as a monopropellant compartment 260, configured to store monopropellant 265, and is fluidly coupled to an embodiment of the propellant control and feed system 300 having a single pressurant tank assembly 310 (e.g., including a first pressurant tank 320) that provides ullage pressure via a pressurant fluid line 377 to the monopropellant 265 within the propellant tank assembly 210.

The monopropellant 265 is delivered from the propellant tank assembly 210 to an embodiment of the propellant pumping system 410 (e.g., via a monopropellant fluid line 387), which in this embodiment comprises a single monopropellant pump 455 controlled by the control system 710 (FIG. 1). The monopropellant pump 455 can have the same or similar features and configurations as the fuel propellant pump 420 and/or oxidizer propellant pump 430 of the bipropellant configuration. As in the bipropellant configuration, the pump-fed propulsion system 110 configured for use with monopropellant 265 (FIG. 2B) further includes embodiments of the recirculation loop assembly 510 (e.g., including a monopropellant recirculation line 523) and pressurized accumulator assembly 610 (e.g., including a monopropellant accumulator 623), which are consistent with the description above relating to FIG. 2A, and are each fluidly coupled to the propellant pumping system 410 and configured to manage monopropellant flow transients, monopropellant pressure regulation, and accumulator charging for the monopropellant.

During operation, the control system 710, such as the control system of FIG. 1, manages the propellant pumping system 410 to increase the monopropellant pressure from an ullage pressure within the propellant tank assembly 310 to a higher downstream pressure (thruster delivery pressure) suitable for delivery to one or more thrusters 800. The pressure of the monopropellant 265 is increased and maintained at higher pressures using pump operation, accumulator charging, and controlled recirculation, resulting in a regulated thruster delivery pressure as described above with respect to the bipropellant system (FIG. 2A).

In this monopropellant embodiment of FIG. 2B, the propellant pumping system 410, recirculation loop assembly 510, and pressurized accumulator assembly 610 are dedicated exclusively to the monopropellant, eliminating the need for separate fuel and oxidizer subsystems while preserving the advantages of pump-fed operation, including rapid response, precise pressure control, and reduced tank mass. This configuration is particularly well suited for small spacecraft (e.g., small ESPA vehicle configurations) where lower volume, lower mass, and system simplicity are important, while still enabling controlled pressure rise from propellant tank ullage pressure to thruster delivery pressure under command of the control system 710.

With continued reference to FIGS. 1-2B, the control system 710 (FIG. 1) is configured to manage operation of the pressurant tank assembly 310, the propellant pumping system 410, and the pressurized accumulator assembly 610. The control system 710 is configured to ensure that propellant is stored at a relatively low pressure within the propellant tank assembly 210 and selectively increased to a high thruster delivery pressure for propulsion, thereby enabling the spacecraft 100 to achieve a desired delta-v, including delta-v on the order of at least 1000 meters per second, while maintaining a compact and low-mass system architecture.

The control system 710 provides coordinated, closed-loop control of pressure, flow, timing, and sequencing across the propulsion system, enabling reliable operation of the spacecraft, including during startup, steady-state thrust, pulsed maneuvering, accumulator charging, and shutdown.

In some embodiments, the control system 710 includes a control unit comprising one or more processors, memory devices, and stored instructions implementing propulsion control algorithms. The memory stores operational logic, configuration parameters, fault thresholds, and adaptive control data used during propulsion system operation. The control unit can execute software routines that determine commanded states, such as for pumps, valves, and accumulators based on sensor inputs and commands.

The control system 710 receives data from a plurality of sensor inputs distributed throughout the propellant control and feed system 300. In various embodiments, the sensor inputs include pressure sensors, temperature sensors, flow sensors, position sensors, and acceleration sensors.

Pressure sensors can be positioned, for example, in the pressurant tank assembly 310, at pump inlets and outlets within the propellant pumping system 410, within the recirculation loop assembly 510, and at accumulator and thruster inlets. Temperature sensors can monitor propellant temperature, pump temperature, and/or accumulator temperature. Data from the sensor inputs can be processed by the control unit to determine current operating conditions and to adjust control outputs dynamically.

In some embodiments, the control system 710 implements one or more software embodiments that define operational logic sequences and control strategies. These software embodiments can include rule-based logic, state-machine architectures, or adaptive control approaches that adjust system parameters in response to observed behavior over time.

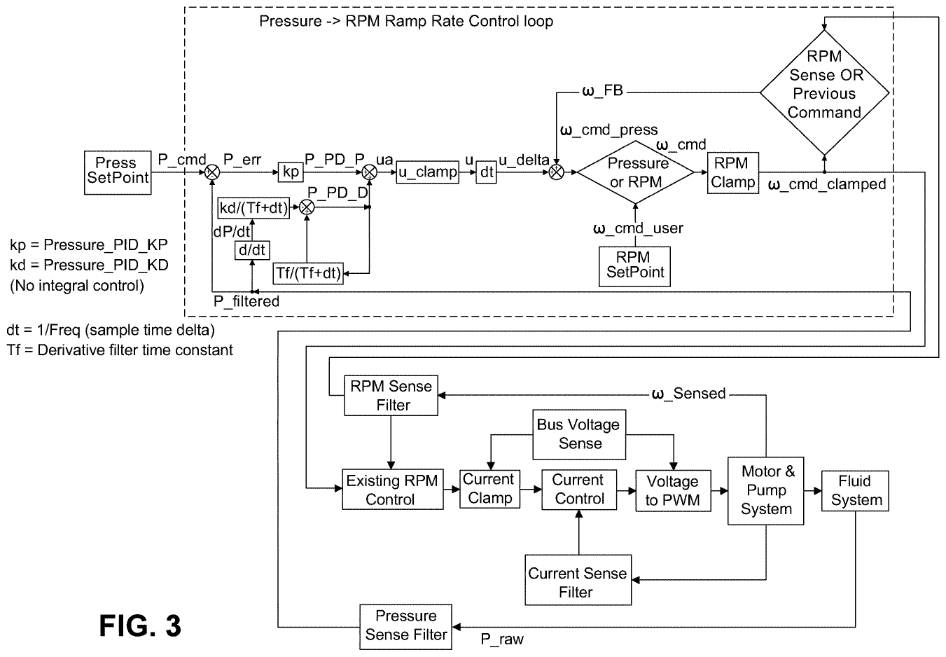

As will be described in greater detail with reference to FIG. 3, the control system 710 can execute specific pump control algorithms governing startup, normal operation, accumulator charging, and shutdown of the propellant pumping system 410. These algorithms leverage the sensor inputs and actuator outputs to ensure stable, efficient, and responsive propulsion system operation.

Through coordinated control of low-pressure propellant storage, high-pressure propellant delivery, accumulator-based buffering, and pump operation, the control system 710 enables the pump-fed propulsion system 110 to deliver high delta-v capability while maintaining compact size, low mass, and high maneuverability. This integrated control approach is fundamental to enabling small spacecraft, such as satellites, to execute complex mission profiles requiring rapid response and precise thrust control.

FIG. 3 illustrates a custom pump control algorithm executed by the control system to regulate operation of the propellant pumping system 410. For example, FIG. 3 can depict a control sequence configured to regulate operation of the fuel propellant pump 420 and the oxidizer propellant pump 430 during startup, steady-state operation, accumulator charging, and shutdown. The algorithm enables a smooth transition between direct speed control and closed-loop pressure control, allowing responsive pump behavior during rapid starts and stops while maintaining precise pressure regulation.

In operation, the pump controller receives a measured pressure value and a corresponding pressure setpoint based on the active operating mode. A speed-change command (uₐ) is computed using a proportional-derivative (PD) control loop, with the derivative term calculated using a backward-difference approximation to estimate the rate of pressure change in real time. This speed-change command is clamped within allowable limits and multiplied by the control loop time step (dt) to produce a speed-ramp command (u_Δ) for the current iteration.

The speed-ramp command is added to either measured motor revolutions per minute (RPM) feedback or the previously commanded RPM to generate a new motor speed command, which is then clamped within allowable operating limits and transmitted to the pump motor controller. The algorithm further supports toggling between direct RPM control and closed-loop pressure control, enabling flexible pump operation across startup, steady-state operation, accumulator charging, and shutdown. This approach provides stable pressure control, minimizes mechanical stress, and supports efficient and reliable propellant delivery and desired delta-v.

In certain embodiments, the spacecraft configurations described herein are characterized by specific delta-v ratings, expressed on both a wet mass basis and a dry mass basis, which are optimized and improved compared to conventionally configured ESPA-class spacecraft employing pressure-fed or lower-performance propulsion systems. As used herein, specific delta-v (wet) refers to the total available delta-v of the spacecraft normalized by the spacecraft wet mass, inclusive of propellant, while specific delta-v (dry) refers to the total available delta-v normalized by the spacecraft dry mass, which does not include propellant. These normalized metrics provide a mass-independent basis for comparing maneuvering capability across spacecraft of differing scale and propellant loading.

In example embodiments corresponding to small, medium, and large ESPA vehicle configurations, the integration of the described pump-fed propulsion systems 110 enables a greater proportion of propellant mass to be used. As provided herein, example values for each ESPA configuration demonstrates an increased specific delta-v (wet), indicating enhanced maneuver capability per unit of launched mass, and a correspondingly increased specific delta-v (dry), indicating enhanced maneuver capability per unit of non-propellant spacecraft mass. These improvements arise, at least in part, from lower propellant storage pressures, reduced structural mass associated with propellant containment, and improved propulsion system scalability provided by the pump-fed architecture of the pump-fed propulsion system 110. The described pump-fed propulsion system 110 configurations provide a scalable approach for improving specific delta-v across a range of ESPA-class spacecraft.

In an example embodiment corresponding to a small ESPA vehicle configuration, the spacecraft can include a pump-fed propulsion system 110 having a propulsion system volume of approximately 1,000 cubic inches (in³) (approximately 16 liters (L)). In certain embodiments, the propulsion system volume can range from approximately 800 to 1,200 in³ (approximately 13 to 20 L), depending on mission requirements and available ESPA payload space. The spacecraft can have a wet mass of approximately 17 kilograms (kg), with example wet mass ranges of approximately 14 to 20 kg, and a corresponding dry mass of approximately 10 kg, with example dry mass ranges of approximately 8 to 12 kg. In this example configuration, the spacecraft can be capable of providing a total delta-v rating of approximately 1,000 meters per second (m/s), with example embodiments providing delta-v values in the range of approximately 800 to 1,200 m/s. Based on the example wet mass, the spacecraft can exhibit a specific delta-v (wet) of approximately 58 m/s-kg, with an associated range of approximately 45 to 70 m/s-kg. Based on the example dry mass, the spacecraft can further exhibit a specific delta-v (dry) of approximately 100 m/s-kg, with an associated range of approximately 80 to 120 m/s-kg. These specific delta-v values demonstrate improved normalized maneuver capability relative to conventional ESPA spacecraft of similar size that employ pressure-fed propulsion systems with higher tank and pressurant mass fractions. The pump-fed propulsion system 110 of the small ESPA vehicle configuration can include one or more propellant tank assemblies 210 having an aggregate propellant tank volume of approximately 5 L, with example ranges of approximately 4 to 6 L, and a corresponding total propellant tank mass of approximately 2 kg, with example ranges of approximately 1.5 to 2.5 kg. In certain embodiments, the pump-fed propulsion system 110 further includes an accumulator configured to support a minimum impulse bit (MIB) capacity of approximately 10 units, with example accumulator capacities ranging from approximately 8 to 12 minimum impulse bits.

In an example embodiment corresponding to a medium ESPA vehicle configuration, the spacecraft includes a pump-fed propulsion system 110 having a propulsion system volume of approximately 10,000 in³ (approximately 163 liters L). In additional example embodiments, the propulsion system volume can range from approximately 8,000 to 12,000 in³ (approximately 130 to 200 L), allowing the pump-fed propulsion system 110 to be scaled within the ESPA payload space while maintaining consistent performance characteristics. The spacecraft can have a wet mass of approximately 166 kg, with example wet-mass ranges of approximately 140 to 190 kg, and a dry mass of approximately 100 kg, with example dry-mass ranges of approximately 85 to 120 kg. In this example medium ESPA vehicle configuration, the spacecraft can be capable of providing a total delta-v rating of approximately 1,500 m/s, with example embodiments providing delta-v values in the range of approximately 1,300 to 1,700 m/s. Based on the example wet mass, the spacecraft can exhibit a specific delta-v (wet) of approximately 9 m/s-kg, with ranges of approximately 7 to 11 m/s-kg. Based on the example dry mass, the spacecraft can further have a specific delta-v (dry) of approximately 15 m/s-kg, with ranges of approximately 12 to 18 m/s-kg. The pump-fed propulsion system 110 of the medium ESPA vehicle configuration can include one or more propellant tank assemblies 210 having an aggregate propellant tank volume of approximately 55 L, with example embodiments ranging from approximately 45 to 65 L, and a corresponding total propellant tank mass of approximately 30 kg, with associated ranges of approximately 25 to 35 kg. In certain embodiments, the pump-fed propulsion system 110 further includes an accumulator configured to provide a minimum impulse bit (MIB) capacity of approximately 50 units, with example accumulator capacities ranging from approximately 40 to 60 minimum impulse bits.

In an example embodiment corresponding to a large ESPA vehicle configuration, the spacecraft includes a pump-fed propulsion system 110 having a propulsion system volume of approximately 100,000 in³ (approximately 1,638 L). In additional example embodiments, the propulsion system volume can range from approximately 80,000 to 120,000 in³ (approximately 1,300 to 2,000 L), allowing for integration within larger ESPA payload spaces or extended mission architectures. The spacecraft can have a wet mass of approximately 1,850 kg, with example wet-mass ranges of approximately 1,600 to 2,100 kg, and a corresponding dry mass of approximately 1,000 kg, with example dry-mass ranges of approximately 850 to 1,150 kg. In this example large ESPA vehicle configuration, the spacecraft can be capable of providing a total delta-v rating of approximately 2,000 m/s, with embodiments providing delta-v values in the range of approximately 1,700 to 2,300 m/s. Based on the example wet mass, the spacecraft can exhibit a specific delta-v (wet) of approximately 1 m/s-kg, with representative ranges of approximately 0.8 to 1.2 m/s-kg. Based on the example dry mass, the spacecraft can further exhibit a specific delta-v (dry) of approximately 2 m/s-kg, with example ranges of approximately 1.6 to 2.4 m/s-kg. The pump-fed propulsion system 110 can include one or more propellant tank assemblies 210 having an aggregate propellant tank volume of approximately 712 L, with example embodiments ranging from approximately 600 to 850 L, and a corresponding total propellant tank mass of approximately 385 kg, with example mass ranges of approximately 330 to 450 kg. In some embodiments, the pump-fed propulsion system 110 further includes an accumulator configured to provide a minimum impulse bit (MIB) capacity of approximately 1,000 units, with example accumulator capacities ranging from approximately 800 to 1,200 minimum impulse bits.

The pump-fed propulsion system 110 allows various-scale propellant storage and impulse delivery to be achieved without the proportional increases in system dry mass, or structural inefficiencies typically associated with pressure-fed propulsion systems, thereby supporting improved specific delta-v performance on both a wet and dry mass basis.

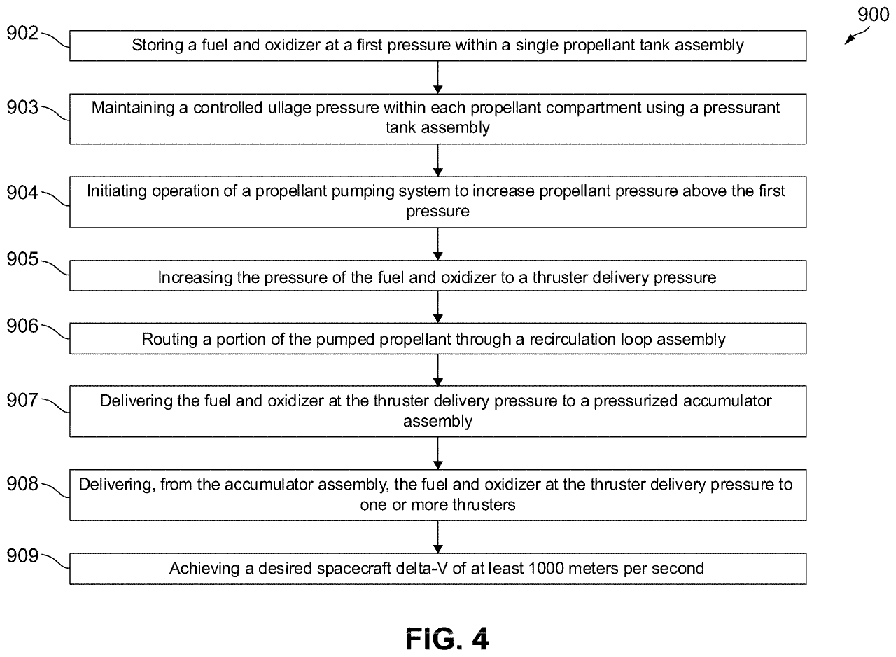

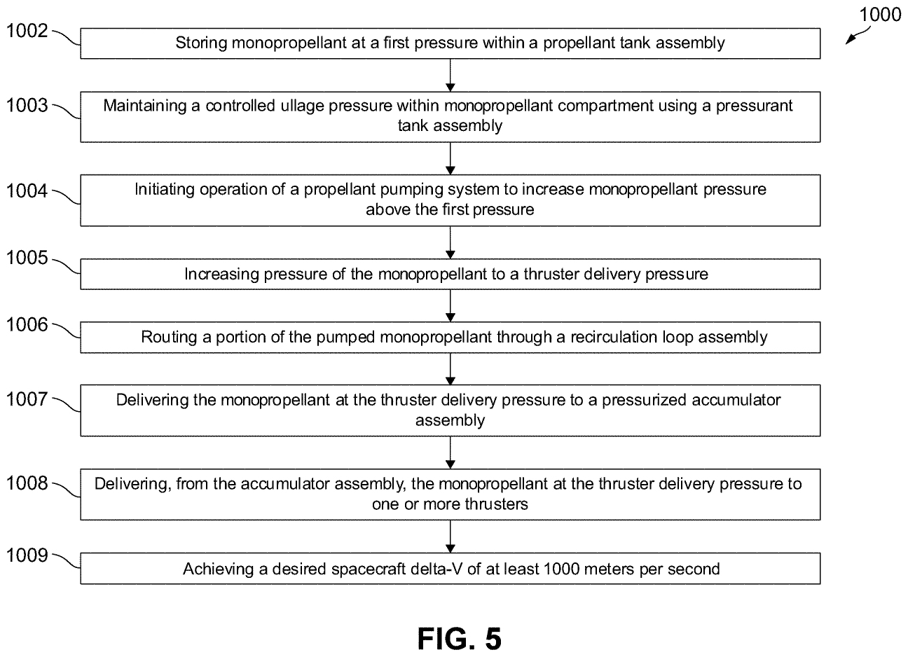

FIGS. 4 and 5 show a first process flow chart 900 and a second process flow chart 1000, respectively, illustrating features of methods consistent with implementations of the current subject matter. It will be understood that other implementations can include additional steps, omit certain steps, reorder steps, or perform steps concurrently without departing from the scope of the disclosure.

At 902, the method can include storing a propellant (e.g., a fuel, an oxidizer) at a first pressure (ullage pressure) within a propellant tank assembly 210. In some embodiments, the fuel is stored within a fuel compartment 230 and the oxidizer is stored within an oxidizer compartment 240, separated by a common bulkhead. The first pressure can correspond to a relatively low ullage pressure, such as less than 100 psia (e.g., approximately 40 to 70 psia, such as approximately 50 psia).

At 903, the method can include maintaining a controlled ullage pressure within each propellant compartment using a pressurant tank assembly 310. In some embodiments, a fuel pressurant tank 320 provides pressurant gas to the fuel compartment 230, and a second pressurant tank 330 provides pressurant gas to the oxidizer compartment 240. The control system 710 can regulate pressurant delivery based on pressure sensor feedback to maintain the ullage pressure within a desired range as propellant is dispensed.

At 904, the method includes initiating operation of a propellant pumping system 410 to increase propellant pressure above the first pressure. In some embodiments, this step includes activating a fuel propellant pump 420 and an oxidizer propellant pump 430, each of which can be operated at a variable speed as commanded by the control system 710.

At 905, the method includes increasing the pressure of the fuel and oxidizer to a second pressure, greater than the first pressure, suitable for delivery to one or more thrusters 800. In some embodiments, the second pressure corresponds to a thruster delivery pressure of greater than 150 psia (e.g., approximately 150 to 500 psia, approximately 275 to 325 psia), achieved downstream of the propellant tank assembly 210.

At 906, the method includes routing a portion of the pumped propellant through a recirculation loop assembly 510 to manage startup transients. In some embodiments, a fuel recirculation line 522 provides a fluid pathway between a fuel pump outlet and a fuel pump inlet, and an oxidizer recirculation line 524 provides a corresponding pathway for oxidizer flow. This step prevents deadheading, mitigates water hammer, and enables controlled pressure ramp-up during pump startup.

At 907, the method includes delivering pressurized fuel and oxidizer to a pressurized accumulator assembly 610 positioned downstream from the recirculation loop assembly 510. In some embodiments, a fuel accumulator 620 and an oxidizer accumulator 630 are charged to the thruster delivery pressure. Each accumulator can include a pneumatic volume to store propellant energy elastically.

At 908, the method includes delivering pressurized fuel and oxidizer from the pressurized accumulator assembly 610 to one or more thrusters 800. In some embodiments, the thrusters are operated in a pulsed mode, continuous mode, or a combination thereof, depending on spacecraft maneuvering requirements.

The method optionally includes executing multiple discrete thruster impulse bits using propellant supplied from the pressurized accumulator assembly 610 without requiring activation of the propellant pumping system 410 for each impulse bit. This step reduces pump cycling, lowers energy consumption, and enables rapid response maneuvering.

At 909, the method includes achieving a desired spacecraft delta-v, including delta-v values of at least 1000 meters per second, such as 1500 meters per second and any of the delta-v values disclosed herein.

The method further includes monitoring system parameters including pressure, temperature, flow rate, and pump speed using sensor inputs 720, and adjusting operation of the pressurant tank assembly 310, propellant pumping system 410, and pressurized accumulator assembly 610 in response thereto using the control system 710.

The method optionally includes regulating pump operation using a pump control algorithm, such as the algorithm described with reference to FIG. 3, to maintain desired pressure, manage transitions between startup and steady-state operation, and recharge the pressurized accumulator assembly 610 as needed.

FIG. 5 illustrates a second process flow chart 1000 describing a method of operating a pump-fed propulsion system 110 for a monopropellant in accordance with one or more implementations of the present subject matter. The method can include additional steps, omit certain steps, reorder steps, or perform steps concurrently without departing from the scope of the disclosure.

At step 1002, the method includes storing a monopropellant within a propellant tank assembly 210 at a first pressure corresponding to a relatively low ullage pressure. In some embodiments, the first pressure is maintained at less than 100 psia (e.g., approximately 40 to 70 psia, such as 50 psia).

At step 1003, the method includes maintaining the ullage pressure within the monopropellant compartment 260 of the propellant tank assembly 210 using a pressurant tank assembly 310.

At step 1004, the method includes initiating operation of an embodiment of the propellant pumping system 410 to increase monopropellant pressure above the first pressure. The pump of the propellant pumping system 410 can be operated at a variable speed under command of the control system 710 to achieve a desired pressure rise.

At step 1005, the method includes increasing the monopropellant pressure to a second pressure (thruster delivery pressure) greater than the first pressure, the second pressure being suitable for delivery to one or more monopropellant thrusters. In some embodiments, the second pressure corresponds to a thruster inlet pressure of greater than 150 psia (e.g., approximately 150 to 500 psia, approximately 275 to 325 psia).

At step 1006, the method includes routing at least a portion of the pumped monopropellant through a recirculation loop assembly 510 to manage system transients. This recirculation mitigates deadheading, limits pressure spikes, and enables a controlled pressure ramp during pump startup.

At step 1007, the method includes charging a pressurized accumulator assembly positioned downstream of the pumping system with monopropellant at the second pressure. The accumulator can include a pneumatic volume configured to elastically store pressurized monopropellant.

At step 1008, the method includes delivering pressurized monopropellant from the accumulator assembly to one or more monopropellant thrusters to generate thrust. The thrusters can be operated in pulsed mode, continuous mode, or combinations thereof.

The method can optionally include executing multiple discrete thruster impulse bits using monopropellant supplied from the accumulator assembly without reactivating the pumping system for each impulse bit, thereby reducing pump cycling, lowering power consumption, and enabling rapid-response maneuvering.

At step 1009, the method includes producing a desired spacecraft delta-v, including delta-v values of at least 1000 meters per second, such as 1500 meters per second and any of the delta-v values disclosed herein.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, for example as would a non-transient solid-state memory or a magnetic hard drive or any equivalent storage medium. The machine-readable medium can alternatively or additionally store such machine instructions in a transient manner, for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The implementations set forth in the foregoing description do not represent all implementations consistent with the subject matter described herein. Instead, they are merely some examples consistent with aspects related to the described subject matter. Although a few variations have been described in detail herein, other modifications or additions are possible. In particular, further features and/or variations can be provided in addition to those set forth herein. For example, the implementations described above can be directed to various combinations and sub-combinations of the disclosed features and/or combinations and sub-combinations of one or more features further to those disclosed herein. In addition, the logic flows depicted in the accompanying figures and/or described herein do not necessarily require the particular order shown, or sequential order, to achieve desirable results. The scope of the following claims may include other implementations or embodiments.

What is claimed is:

1. A spacecraft pump-fed propulsion system, comprising:
a propellant tank assembly comprising at least one compartment for containing a propellant;
a pressurant tank assembly in fluid communication with each of the at least one compartment, the pressurant tank assembly maintaining an ullage pressure within each of the at least one compartment;
a propellant pumping system in fluid communication with the propellant tank assembly and one or more thrusters, the propellant pumping system increasing a propellant pressure from the ullage pressure to a thruster delivery pressure;
a recirculation loop assembly in fluid communication with a pump outlet of the propellant pumping system, the recirculation loop assembly holding a volume of propellant to mitigate or reduce fluid transients during startup or shutdown of the propellant pumping system;
a pressurized accumulator assembly downstream from the recirculation loop assembly and configured for storing the propellant at the thruster delivery pressure and delivering the propellant at the thruster delivery pressure to at least one thruster of the one or more thrusters; and
a control system configured to manage operation of at least the pressurant tank assembly, the propellant pumping system, and the pressurized accumulator assembly to regulate pressure and flow of the propellant, the control system ensuring the propellant is stored in the propellant tank assembly at the ullage pressure and the propellant pressure is increased downstream from the propellant tank assembly to the thruster delivery pressure for generating a delta-v associated with the spacecraft pump-fed propulsion system that is at least 1000 meters per second.

2. The spacecraft pump-fed propulsion system of claim 1, wherein the at least one compartment comprises a single monopropellant compartment configured to contain a monopropellant.

3. The spacecraft pump-fed propulsion system of claim 2, wherein the propellant pumping system comprises a single monopropellant pump configured to pump the monopropellant from the propellant tank assembly to the pressurized accumulator assembly.

4. The spacecraft pump-fed propulsion system of claim 1, wherein the at least one compartment of the propellant tank assembly comprises a fuel compartment for containing fuel and an oxidizer compartment for containing oxidizer, the propellant tank assembly comprising a common bulkhead separating the fuel compartment and the oxidizer compartment.

5. The spacecraft pump-fed propulsion system of claim 4, wherein the propellant pumping system comprises a fuel propellant pump in fluid communication with the fuel compartment and an oxidizer propellant pump in fluid communication with the oxidizer compartment.

6. The spacecraft pump-fed propulsion system of claim 5, wherein the recirculation loop assembly comprises a fuel recirculation line in fluid communication with the fuel propellant pump and an oxidizer recirculation line in fluid communication with the oxidizer propellant pump.

7. The spacecraft pump-fed propulsion system of claim 6, wherein the pressurized accumulator assembly comprises a fuel accumulator configured to store the fuel at the thruster delivery pressure and an oxidizer accumulator configured to store the oxidizer at the thruster delivery pressure.

8. The spacecraft pump-fed propulsion system of claim 7, wherein the control system is configured to independently regulate operation of the fuel pump and the oxidizer pump to increase respective pressures of the fuel and the oxidizer from respective ullage pressures to respective thruster delivery pressures.

9. The spacecraft pump-fed propulsion system of claim 1, wherein the ullage pressure is less than 100 psia.

10. The spacecraft pump-fed propulsion system of claim 9, wherein the thruster delivery pressure is greater than 150 psia.

11. The spacecraft pump-fed propulsion system of claim 1, wherein the spacecraft pump-fed propulsion system has a dry mass of 100 kg and an associated specific delta-v rating of 15 m/s-kg.

12. The spacecraft pump-fed propulsion system of claim 1, wherein the generated delta-v is at least 1500 meters per second.

13. The spacecraft pump-fed propulsion system of claim 1, wherein the control system is configured to control operation of the propellant pumping system by:
receiving a measured pressure from at least one pressure sensor associated with the propellant pumping system;
receiving a pressure setpoint corresponding to a commanded operating state;
determining a pressure difference based on a difference between the measured pressure and the pressure setpoint;
generating a pump speed change command based on the pressure difference;
limiting the pump speed change command to within a predetermined range;
applying a control loop time interval to the limited pump speed change command to generate a pump speed ramp command; and
controlling a rotational speed of at least one propellant pump of the propellant pumping system based on the pump speed ramp command by combining the pump speed ramp command with one of (i) a measured pump speed and (ii) a prior pump speed command to generate a new pump speed command, and limiting the new pump speed command to within an allowable range.

14. A method of operating a pump-fed propulsion system of a spacecraft, the method comprising:
storing a propellant at an ullage pressure within a propellant tank assembly comprising at least one compartment;
maintaining the ullage pressure within each of the at least one compartment using a pressurant tank assembly;
increasing pressure of the propellant from the ullage pressure to a thruster delivery pressure that is greater than the ullage pressure using a propellant pumping system;
routing pressurized propellant through a recirculation loop assembly to manage startup and shutdown transients of the propellant pumping system;
storing the propellant at the thruster delivery pressure within a pressurized accumulator assembly positioned downstream from the propellant pumping system;
delivering, from the pressurized accumulator assembly, the propellant at the thruster delivery pressure to one or more thrusters; and
controlling operation of the pressurant tank assembly, the propellant pumping system, and the pressurized accumulator assembly using a control system such that the propellant is stored at the ullage pressure and selectively increased to the thruster delivery pressure to generate, by the one or more thrusters, a delta-v that is at least 1000 meters per second.

15. The method of claim 14, wherein the ullage pressure is less than 100 psia.

16. The method of claim 15, wherein the thruster delivery pressure is greater than 150 psia.

17. The method of claim 14, wherein maintaining controlled ullage pressures comprises delivering pressurant gas to each of the at least one compartment.

18. The method of claim 14, wherein the at least one compartment comprises a single monopropellant compartment configured to contain a monopropellant.

19. The method of claim 14, wherein the at least one compartment of the propellant tank assembly comprises a fuel compartment for containing fuel and an oxidizer compartment for containing oxidizer, the propellant tank assembly comprising a common bulkhead separating the fuel compartment and the oxidizer compartment.

20. The method of claim 14, wherein delivery of the propellant from the pressurized accumulator assembly enables execution of thruster impulse bits without requiring activation of the propellant pumping system for each thruster impulse bit.

21. The method of claim 14, wherein the generated delta-v is at least 1500 meters per second.

22. The method of claim 14, further comprising controlling the propellant pumping system, comprising:
receiving a measured pressure from a pressure sensor associated with the propellant pumping system;
receiving a pressure setpoint corresponding to a commanded operating state;
determining a pressure difference based on a difference between the measured pressure and the pressure setpoint;
generating a pump speed change instruction based on the pressure difference; and
controlling a rotational speed of a propellant pump of the propellant pumping system in response to the pump speed change instruction.

23. The method of claim 22, further comprising:
limiting the pump speed change instruction to within a predetermined range;
generating a pump speed ramp command based on the pressure difference; and
combining the pump speed ramp command with a prior pump speed command or measured pump speed to generate a new pump speed command; and
limiting the new pump speed command to within an allowable range.
